(19) United States
(12) Patent Application Publication
(10) Pub. No.: US 2003/0019798 A1
(43) Pub. Date: Jan. 30, 2003

(54) System and method for processing household laundry at a commercial facility

(76) Inventors: Stephen Franklin Capps, Woodlands, TX (US); Gene Milas, Tampa, FL (US)

Correspondence Address: Yukiko Iwata, Shell Oil Company, Legal - Intellectual Property, P.O. Box 2463, Houston, TX, 77252-2463, US

(21) Appl. No.: 10/200,851

(22) Filed: Jul. 22, 2002

Related U.S. Application Data
(62) Division of application No. 09/745,952, filed on Dec. 21, 2000.

(51) Int. Cl. B07C 5/00; D06F 37/00

(52) U.S. Cl. 209/630; 209/703; 209/937; 68/28; 68/210; 68/245

(57) ABSTRACT

A system and method for efficiently laundering multiple loads of household laundry at commercial facilities. By using the advantages of modules having at least one dirty laundry working surface and at least one clean laundry working surface disposed between at least one washing machine and at least one dryer reduces the inefficiencies associated with previous arrangements. A plurality of these modules allows for the sharing of a partial common perimeter to increase workspace efficiency. In a preferred embodiment, the inclusion of at least one common transport medium and/or identification system allows for further improvements.

### FIELD OF THE INVENTION

The present invention relates to improved methods and apparatus for processing household laundry. In a preferred embodiment, this system and method improves the processing of household laundry at commercial facilities.

### BACKGROUND OF THE INVENTION

Although household laundry historically has been laundered in the home, the outside processing of this laundry as part of a service offering is sought by several segments of the population. Interested clients include but are not limited to upscale apartment dwellers, dual income households, single adults, time pressured suburban families, adults in assisted living, affluent households, and college students. Individuals in these markets are driven by the desire to spend less time on household tasks in order to improve the quality of life.

Historically, commercial laundering of household laundry has been offered by any one of several businesses, including self-service coin operated laundries, dry cleaning plants, dry cleaning agencies, and shirt laundries. Because a number of manual steps are required for the processing of household items, the process historically has been labor intensive and expensive. Pricing of existing services vary, but generally are greater than one U.S. dollar per dry pound of laundry. Successful growth of the emerging business of home laundry service will depend upon reduction in unit price by improved productivity in central processing, for example by reducing direct labor costs or through efficiencies of scale.

Many existing laundering facilities already are operating at optimal efficiency given the limitations of the existing methods and equipment. Most existing industrial laundry facilities are designed for very large loads of similar materials, such as towels, sheets, or uniforms, rather than for household laundry. Moreover, items from several customers may be commingled into overall categories of laundry, such as colored and white, in order to efficiently load the cleaning equipment. Commingled laundered items must be sorted and reassembled before return to the customer, which increases labor costs.

Although many modem self-service coin-operated laundries are clean, well finished, and equipped with premium equipment capable of commercial laundering of household laundry, such laundries are designed for a “walk-in” business rather than efficient processing of a large volume of household laundry. Self-service laundries also lack systems for order tracking and efficient quality control.

In a laundry service business, household laundry is generally received as a plurality of independent loads of laundry from a plurality of independent customers. Independent loads may be picked up from individual customers at their homes or the customer may take the laundry to a service facility. Customer identification and laundering information may be recorded either by an employee at the service facility, by a route driver, or via equipment provided for the customer to use.

Customer order placement, identification, tracking, delivery, and payment may be hand written or automated. The customer is usually provided with forms at the drop-off on which to indicate wash specifications, including, but not necessarily limited to requirements related to detergent, softener, scents, bleach, and the like. Multiple order tickets can be printed at intake and used, e.g., for identification purposes, as attachments to the bagged hanging items.

Facilities and methods are needed to efficiently launder a plurality of loads of household laundry. The following example provides an illustration of the inefficiencies in the current laundering process that would be used to launder a plurality of independent orders in a conventional laundromat facility. There are several phases of a typical laundry process. These phases may include receiving the dirty laundry, sorting the dirty laundry, moving and loading the sorted dirty laundry into washing machines, washing the dirty laundry, unloading and moving the washed laundry to dryers, loading and drying the washed laundry, unloading and moving the dried laundry, and folding and/or hanging and packaging the dried laundry. Each of these phases can benefit from the present invention.

First, with regard to in-process handling of customer orders, personnel must find and retrieve laundry carts from various locations in the facility as needed to sort, load, or unload. These might include distances from a few feet to over about 30 to about 40 feet. Next, personnel must handle incoming and completed orders. This involves personnel to stack laundry bags on carts and pushing these to work areas for processing. Additionally, personnel must stack and hang completed orders in carts and push to a staging area for delivery. Furthermore, personnel must offload laundry orders from carts to storage shelves. Also, double handling occurs when incoming orders are offloaded to a staging area, and then lifted again to carts for processing.

Turning to the next phase, chemical dosing, personnel must measure and pour individual amounts of detergent, bleach, and fabric softener into machine dispensers. The next phase, washer cycle activation, requires personnel to push carts a variable distance from the sorting area to washers, load washers, select type of wash cycle, then activate machine(s). In the following stage, dryer cycle activation, personnel must push carts a variable distance from the washing area to dryers, load dryers, select type of dry cycle, and then activate the machine(s).

Following this stage, personnel must unload dryers and fold and/or hang garments. The requires the unloading of all dryers as cycles finish, placing flat items in a cart, and “draping” hanger items or wrinkle-sensitive items over a crossbar on a laundry cart used for in-process storage. In the folding phase, operators using substantially differing methods fold items. Next, personnel must package hanger items and hang those items on a cart crossbar at the workplace. This stage typically includes obtaining and tearing plastic bags from a roll and sliding them over groups of garments held in hand. Personnel then must return them to the cart rack until order is completed.

In addition, the frequent need to manually lift, handle, and transport heavy and bulky laundry bags creates an environment where personnel health and safety may become issues.

### SUMMARY OF THE INVENTION

The present invention provides a laundering system comprising at least one module wherein each module comprises at least one clean laundry working surface and at least one dirty laundry working surface, at least one washing machine, at least one dryer, at least one work cart, wherein the at least one least one clean laundry working surface and the at least one dirty laundry working surface are disposed between at least one washing machine and at least one dryer.

In a preferred embodiment, the system comprises at least two of these modules, each having an outer perimeter, wherein a portion of the perimeter of the first module is a portion of the perimeter of the second module to form a common perimeter. This arrangement allows for the first and the second module to share at least one component such as a large capacity washer.

The dirty laundry working surface is a preferred location to manage and handle soiled and unlaundered materials as they enter the system. The clean laundry working surface is a preferred location to manage and handle materials in the system after they have been washed. In a preferred embodiment, it is envisioned that at least one working surface is a top of a table. One embodiment comprises a single table having a divider that defines a dirty laundry working surface and a clean laundry working surface.

The system may also include a packaging area, which may include but not be limited to equipment and supplies for packaging and identification of hanger items. The inclusion of supplies storage, sinks, lockers, and similar areas is considered to be within the scope of the invention. Another aspect of the invention is the arrangement of these elements to improve the efficiency of the invention. In a preferred embodiment at least one working surface is located less than about seven feet, more preferably about six feet, most preferably about five feet from each washing machine and each dryer included in the module. Compared to present commercial facilities, the grouping of the elements in the module improves operator visibility for controlling and monitoring the process. In addition, efficiency is improved due to the proximity of the elements of the module. The use of a plurality of modules allows for a scalable laundry operation that further benefits from the inclusion of transport media, identification systems, storage areas, and similar elements. This arrangement may be used to adapt current commercial facilities to commercially process household laundry.

The use of modules offers many advantages. Each module and operator is independent of each other module and operator. Each module has all of the equipment and supplies required for each shift of operation. Dryers may be arranged back-to-back with a common access room and/or washers with washer service tunnels for air handling plenums and plumbing, respectively. Washers may be arranged back-to-back with common access for water supply, chemical dosing systems, and electrical power. Further, no long transport is required from sorting to washing to drying to packaging.

Bagged, unsorted orders may be delivered to each module by a transport medium such as an overhead conveyor rail. Packaged, completed orders are taken away and delivered by transport medium to a central staging area for loading into delivery vehicles. In the operator workspace, at least one dirty working surface is used for sorting and at least one clean working surface is used for folding and packaging.

Separation of the work area for these tasks reduces the possibility of contaminating clean items with dirt or contaminants from incoming laundry, and minimizes the need for workspace cleaning. Each operator is responsible for all output of a module, including responsibility for all supplies necessary for operation of the module and for the overall quality level achieved by the module.

Modules are preferably positioned side-to-side and end-to-end in the number required to support the expected volume. The unique equipment, layout, and work flow design of the present invention effectively reduces the time required to accomplish what has historically been a very labor-intensive process. The concept improves productivity by elimination and/or redesign of a number of inefficient and extraneous materials-handling tasks that are present in existing facilities for the commercial laundering of household laundry.

In contrast to the process described in the Background of the Invention, the following offers some of the improvements that are offered by the system and method as described and claimed herein. With references to the same stages discussed therein, the following improvements are offered by the present invention.

With regard to the in process handling of customer orders, laundry carts are dedicated to each workstation “module,” never greater than about fifteen feet away. The handling of incoming orders is such that they are loaded directly to a transport medium and delivered to individual operators on demand. The completed orders are reloaded to the transport medium, transported to delivery staging, and sorted by delivery area or zone. With reference to chemical dosing, all chemical dosage can be pre-determined and automatic, based on a pre-programmed controller in the washing machine, enabling “one button” operator selection of a wash program. Automatic dosing also precludes random spills and stains from bleach and offers savings in cost of chemicals by bulk container purchase and controlled dispensing.

Turning to the washer cycle activation stage, personnel may turn about 180° from sorting posture, move carts slightly if required, and load the washers. Personnel may select pre-programmed wash programs by number and then activate the machine. In comparison to current laundromat facilities, the overall duration of washing machine cycles may be reduced, due to efficiencies of more precise chemical control and programmatic control of wash temperatures, fill levels, and machine stages. During the dryer cycle activation, personnel may push carts directly to the dryers through a path under the table working surfaces. Personnel may then select pre-programmed dryer programs by number and activate the machines. The dry time may be significantly less than current methods, due to use of residual moisture sensing and high heat and airflow machines.

During the unloading of the dryers and folding or hanging of the garments, personnel may unload dry items directly to the clean working surface, saving duplicate handling for “draping.” Partially full or unattended dryers may sense cycle completion based on moisture content and switch to an “air fluff” mode to prevent wrinkling. With reference to the folding stage, personnel may use standardized and documented procedures that address the order of folding, treatment of buttons and zippers, grouping for packaging and hanging, and other concerns. Concerning packaging of hanger items, personnel may place hanging garments on a bagging apparatus in a “bag & tag” area of the modular workplace, adjacent to the loading area for the transport medium. Here, personnel may place bagged goods on a hanger rod to await order completion.

The invention will improve workflow and continuity. Laundry may be processed in a dedicated facility on a continuous basis, maintaining a constant level of work in process and more fully utilizing people and equipment. Moreover, all materials required to fulfill an order may be maintained at the workstation modules. These include hangers, bags, ties, documents, and similar items. The workstation operator may be autonomous within his/her area and may be responsible for supply maintenance as well as output and quality. Finally, transport media can move all incoming and outgoing bags and packages, mitigating potential health and safety issues that may exist with manual material handling of heavy and bulky items.

### BRIEF DESCRIPTION OF THE DRAWINGS

FIG. 1 illustrates a preferred arrangement of a two module system of the present invention;

FIG. 2 illustrates a preferred arrangement of a multiple module system of the present invention including input/output staging areas; and

FIG. 3 illustrates a preferred method of the present invention.

### DETAILED DESCRIPTION OF THE INVENTION

The present invention provides an improved method and apparatus for commercial or central laundering of a plurality of independent loads of laundry, herein called household laundry. The invention comprises a method, a facility layout, and a workflow design that allows the facility to operate efficiently while maintaining quality control. This invention is directed to laundering and cleaning techniques utilizing aqueous solutions.

Household laundry processing is meant to include a process for receiving, sorting, washing, drying, folding, and packaging volumes of household laundry at an industrial or commercial laundry facility. Preferably the process also involves transporting the household laundry to and from a point of service facility. “Household laundry” is meant to include, but not be limited to any item found in a home, including garments, clothes, machine-washable suits, linens, towels, bedding materials and the like. Although commercial laundry facilities typically are designed to process only a few homogeneous types of items, such as napkins, bed linens, towels, tablecloths or uniforms, the present invention processes any type of household laundry comprising substantially any type of soil.

Briefly summarized, the present invention accomplishes commercial laundering of household laundry using a series of substantially identical, self-contained modules. The term module or modules means a self-contained work station comprising all of the equipment required to receive, sort, wash, dry, fold, and package household laundry without commingling household laundry received from different customers. The arrangement of the modules maximizes the workspace efficiency by using modules to which laundry may be preferably distributed by at least one transport medium.

The system may be arranged in a variety of configurations. The following figures represent preferred embodiments. Those skilled in the art will recognize that substantial deviation from the arrangements described herein will benefit from the improvements of the invention. Additionally, like elements are noted by the same element number throughout.

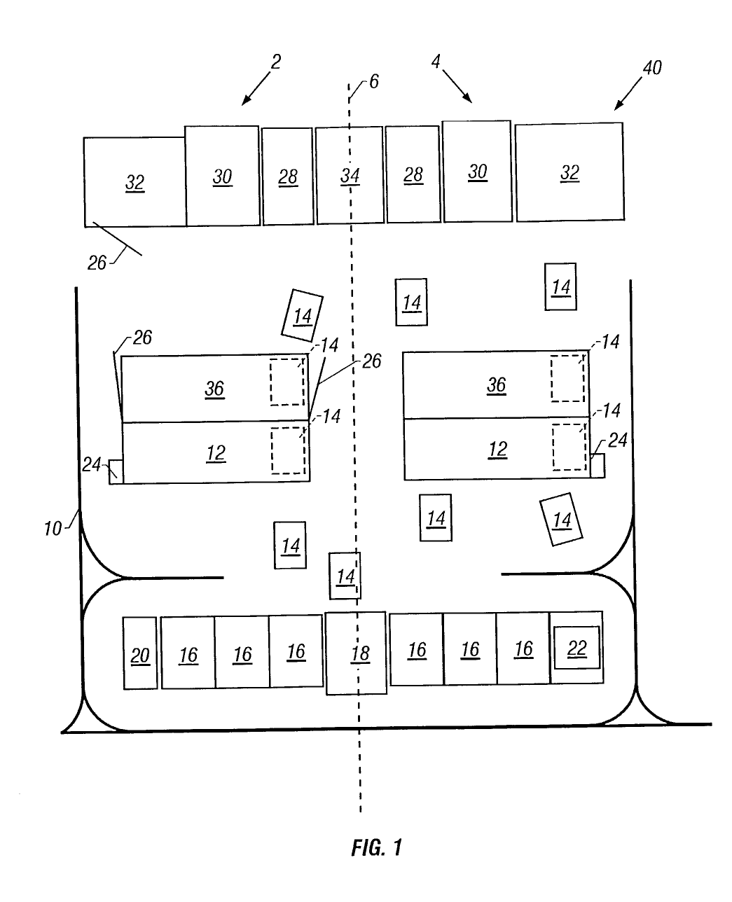

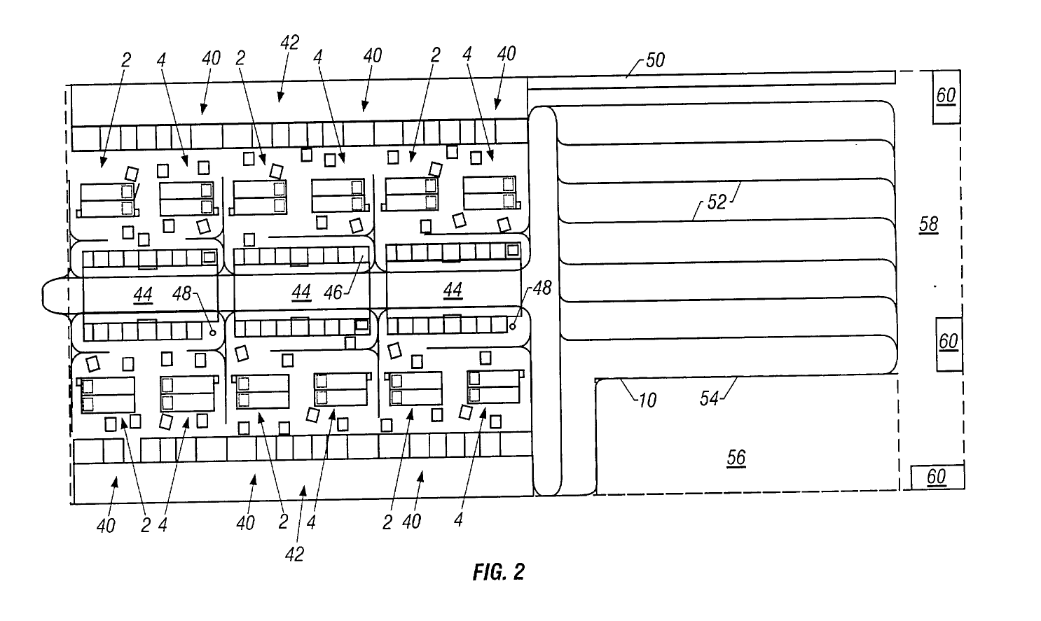

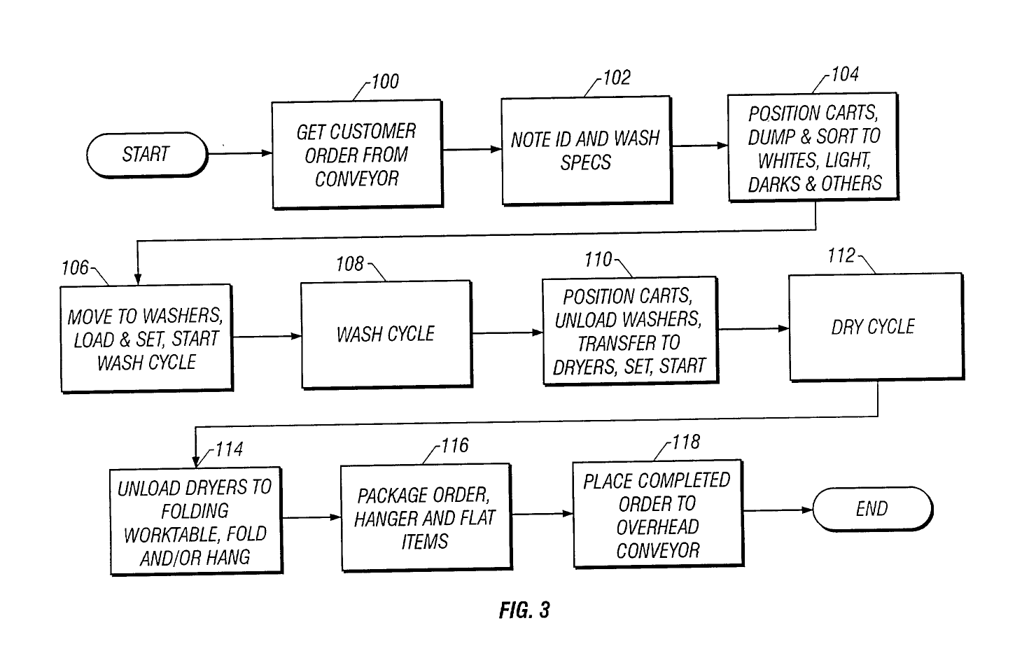

FIG. 1 shows a preferred arrangement of a two module system of the present invention. A pair 40 of modules 2 and 4 is shown. Each module 2 and 4 is a separate, self-contained unit shown by the common perimeter dotted line division 6. In order to maximize floor space efficiency, each module 2 and 4 may be a substantial mirror image of the adjacent module from the dotted line. In the alternative, a plurality of modules 2 and/or 4 may be included to form a larger overall system. Notably, each module 2 and 4 may share components such as the washer 18 and the supplies storage area 34 that will be discussed in greater detail herein. To simplify the following description with reference to FIGS. 2-3, like numbers will be used for like elements throughout the description.

In a preferred embodiment, the modules 2 and 4 are preferably rectangular, having four edges. One edge of the rectangle (the dotted line 6) defines a common perimeter between module 2 and module 4. As will be shown with reference to FIG. 2, this pair 40 of modules 2 and 4 may share additional common perimeters with additional modules or pairs, as shown in FIG. 2, to form a preferred embodiment of a multiple module layout of the system.

A transport medium 10 is shown herein that may facilitate the movement of laundry to and from modules 2 and 4 and provide a method of moving laundry throughout the system. Those skilled in the art will recognize that any conveyor system, powered belt system, roller system, dragline system, automatically piloted vehicle, or any non-manual mechanical device falls within the scope of the invention. This transport medium 10 with attendant carriers also provides a preferred method of storing incoming laundry orders, orders in process, and completed orders as shown in FIG. 2. Each module 2 and 4 comprises a sorting working surface 12, a folding working surface 36, at least one washer 16 and/or 18, at least one dryer 28 and/or 30, and at least one cart 14. Additional features in each module 2 and 4 may include at least one locker 20, at least one utility sink 22, an identification system 24, swivel hanger rods 26, at least one area for bagging and tagging hanger items 32, at least one supplies storage area 34, and similar elements that may aid in the laundry process.

On average, a typical consumer order is between about 35 and about 40 pounds and each order is laundered separately. The machines used to launder individual orders can be similar to those used in a commercial self-service laundry. Suitable washers for this process include but are not necessarily limited to those that can accommodate from about 10 to about 50 pounds of laundry. The 50-pound machines typically are reserved for very large items such as comforters and bedspreads.

As shown herein, each module includes or shares at least one 18-25-pound front loading washer 16 and/or at least one 50-pound front loading washer 18. Suitable dryers include but are not necessarily limited to those that can accommodate from about 10 to about 50 pounds of laundry. In a preferred embodiment each workstation contains at least one 30-pound stacked dryer 28 and/or at least one 50-pound dryer 30.

Moreover, each module 2 and 4 comprises a plurality of wheeled laundry carts 14 for handling dirty laundry and clean laundry. These may be supplemented by a quantity of smaller lightweight plastic laundry baskets sized to fit inside of the larger carts 14. The sorting working surface 12 and the folding working surface 36 are typically arranged to be similar in height and size. In a preferred embodiment, these working surfaces 12 and 36 have smooth stainless steel tops and are formed as a single table divided into a dirty laundry working surface for sorting 12 and a clean laundry working surface for folding and packaging 36. Alternatively, surfaces of 12 and 36 may be of a laminate material, wood, or other metals.

In the preferred embodiment, the working surfaces 12 and 36 are designed such that the plurality of wheeled laundry carts 14 may pass underneath the working surfaces 12 and 36 without obstruction. Also, the area underneath working surfaces 12 and 36 may be used for storage of work in process. Each module 2 and 4 may have an identification system 24 for tracking customer orders. This identification system 24 preferably comprises an electronic scanner and/or a ticket printer. The identification system 24 may include or be linked to additional elements such as a computer and/or display needed to read, process, and/or decode the customer identification and display filed information related to the order. This identification system 24 allows for the generation, identification, and tracking of laundry throughout the overall system. This system 24 may include an electronic database having a record for each customer and order.

Lockers 20 may be included for each operator to store personal belongings and a common supply storage area 34 for operating supplies. All necessary supplies, including packaging, pens, tags, cleanup supplies, and promotional materials are stored for easy access in each module. The supplies can be checked daily and replenished as needed at the beginning or end of each work shift.

FIG. 2 shows a preferred arrangement of the modules 2 and 4 to produce a more efficient and productive system. The modules 2 and 4 are grouped in pairs 4 to maximize floorspace efficiency. As shown herein, modules 2 and 4 continue to share a common perimeter with one another to form a pair 40, but these modules 2 and 4 share common perimeters with additional modules 2 and 4 to form a plurality of pairs 40. This configuration may be increased to accommodate virtually any scale of operation.

Though the preferred embodiment shows a plurality of pairs 40 comprising substantially mirror image modules 2 and 4, those skilled in the art will recognize that this represents but one embodiment. The inclusion of any permutation or combination of module 2 and/or 4 is to be considered to be within the scope of the invention as described herein.

The arrangement of modules 2 and/or 4 in a configuration such as the configuration shown in FIG. 2 allows for a scalable operation of the system. Moreover, the arrangement of pairs in this or a similar configuration may include at least one dryer service access room 42 and at least one washer service tunnel 44. Additional features of the invention may include additional safety features such as at least one fire extinguisher 46 and/or at least one emergency eye wash 46.

The modules 2 and 4 are serviced by the transport medium 10 that allows for the movement of laundry throughout the system. It is preferable to form accumulation lanes 52 for sorting and storage of finished orders. Further, the present invention benefits by preferably including at least one queue 54 in the transport medium for reinsertion of empty carriers to the system. As shown herein, the system is configured to also accommodate a truck unloading and order storage area 56, a delivery staging and truck loading area 58, and at least one utility worktable 60 for delivery driver use.

Turning to the operation of the system, FIG. 3 shows a preferred method of using the system and the preferable operation of module 2 and/or 4 with reference to the elements described in FIGS. 1-2.

The route driver or an on-premises employee may weigh the incoming laundry at the facility using a suitable weighing apparatus. A preferred weighing apparatus includes, but is not necessarily limited to, an electronic or mechanical scale. Measurement to one decimal place is sufficient. The weight reading from the electronic scale preferably is electronically entered into the identification system 24 for each customer's order.

The plurality of independent loads of laundry, along with their identification media, are delivered to a central laundry facility, such as the one shown in FIG. 2. The laundry is unloaded at the receiving point 56 and transported via transport medium 10 to the module 2 and 4.

The customer may either be provided with a reusable bag bearing an identification tag, or the route driver or an on-premises employee at the processing location may prepare and affix identification to the load. A preferred identification media comprises an electronically readable material. In a preferred embodiment, the identification media is a reusable material including, but not necessarily limited to bar-coded tickets, color-coded or numbered tags, magnetic chits, or magnetic cards.

After being received, the customer order travels along transport medium 10 to a module 2 or 4. The transport medium 10 should preferably deliver the customer order to an area proximate to the dirty laundry working surface 12. The operator will remove the customer order from the transport medium 10 in Step 100. Though a single operator preferably operates each module 2 or 4, these modules may be designed to accommodate a plurality of operators.

Using the identification system 24, the operator may determine the identification that shall include the wash specifications in Step 102 by examining the identifier that will remain with the laundry throughout the process. This identifier may preferably, be placed on or near the materials being processed. The identification system may also include an electronic scanner that may activated by the operator to access data comprising the customer identification, to print order tickets, and to display the associated wash specification data.

After Step 102, the operator may position the carts 14 for the sorting Step 104. The sorting operation begins when the customer order arrives at the processing module 2 or 4 and the operator places the laundry bag to the dirty laundry working surface 14. The operation ends when sorted clothes are moved to the washing machines 16 and/or 18. The operator will unload the customer bag from the transport medium 10. The operator will open the bag by loosening the drawstring closure. After obtaining the customer name and order data, the identification media is temporarily placed aside.

The operator preferably obtains three laundry carts 14 and positions them adjacent to the working surface 12, so that clothing and laundry items may be easily placed into the carts 14 without taking steps or significantly rotating the body from position at the dirty laundry working surface 12.

For small and medium-sized loads (up to approximately 35 pounds), the operator will open the drawstring fully and invert the bag to dump contents to the working surface 12. The operator will then close the drawstring and place the empty bag into one of the three carts 14, for “light colors” as explained below, for washing and eventual return to the customer. For larger and heavier loads, the operator will pull the bag contents onto the working surface 12 without inversion of the bag.

Using preferred procedures, the operator will then sort the laundry into carts 14 based on wash load types: “whites,” “light colors,” and “darks.” Other items, such as “delicates,” comforters, or dark items which might bleed color should be held aside on the dirty working surface 12 or in a cart 14 for separate wash treatment. The operator should place non-washable items aside for later return to the customer.

In a preferred method, the operator should choose the largest items on top of the stack first. For example, if towels or sheets are easily grasped, the operator should pull these first, leaving smaller items for later. As the sorting stack becomes smaller, the operator should leave small “white” items such as athletic socks, briefs, washcloths, etc., on the working surface. After all other (colored) items have been placed into carts 14, the operator should “sweep” all these remaining items into the “whites” cart together.

The operator should not turn any clothes or socks “right side out” unless they are knotted or rolled into a ball. Additionally, the operator should not close zippers or button/unbutton shirt lapels. Dress or sport shirts with full-length front buttons should be open for washing. The operator should check pockets in trousers, shirts, or slacks by feeling from the outside of the garment or around the pocket insert. The operator should not insert a hand into pockets.

When all items have been sorted, the operator should position the carts 14 adjacent to washing machines to begin the washing procedure in Step 106.

The washing operation of Step 106 begins when the sorted garments are placed adjacent to the washing machines 16 and 18, and ends when the washed garments are unloaded and transported to the dryers 28 and 30 in Step 108.

Starting with a single cart 14, the operator should use the following preferred procedure to load and activate the washers:

1. Place the customer order identification media at the machine 16 or 18 for each load.

2. Open the washer 16 or 18 door fully and insert the contents of the cart 14, taking care to keep garments pushed away from the door seal area.

3. Close and lock the door.

4. Repeat steps 1 through 3 for the remaining carts 14 and loads that have been sorted by fabric type.

5. Returning to the first machine 16 or 18, check the order identification for the customer-specified wash program.

6. Enter the program number into the electronic control on the washer faceplate.

7. Press the start button to activate the machine 16 or 18 and begin Step 108.

8. Repeat steps 5 through 7 to start the remaining machines 16 and 18.

9. Return empty carts 14 to an area under the working surfaces 12 and/or 36 until next use in sorting clothing or unloading washers 16 and 18.

10. Following completion of the wash cycle, unlock the washer doors and place the wet garments into a laundry cart 14.

11. Retrieve order identification media and keep with carts 14. Using additional carts 14 as required, unload the remaining washers 16 and 18.

12. Push the loaded carts 14 preferably under the working surfaces 12 and 36 to the dryers 28 and 30 on the opposite side of the module 2 or 4.

13. If dryers 28 and/or 30 are available, pull the carts 14 adjacent to the dryers 28 and 30 to prepare for loading (see Step 112 for dryer operation).

The drying operation begins when the washed garments are placed into the dryers 28 and 30 in Step 110 and ends when the dryer door is opened for unloading and further processing in Step 114.

Starting with a single cart 14, use the following procedure to load and activate the dryers:

1. Place the customer order identification media at the machine 28 or 30 for each load.

2. Open the dryer door fully and insert items from the cart 14, taking care to keep garments pushed away from the door seal area. In a preferred embodiment, some loads from the washers 16 or 18 may be mixed for drying if the items are similar in fabric and weight. For example, heavy towels may be mixed with denim jeans, and cotton/polyester sheets may be mixed with shirts and undergarments. Extremely heavy or large items such as bathroom rugs, spreads, or comforters should be handled separately (see also Step 108 for washer operation).

3. Close and lock the door. Activate the dryer by selecting a drying program for the type of garments in the machine and depressing the Start button to begin Step 112.

4. Repeat steps 1 through 3 for the remaining carts 14 and washed loads.

5. Return empty carts 14 preferably to an area adjacent to or under the working surfaces 12 and 36 until next use in unloading washers 16 and 18.

6. Dryers 28 and 30 are preferably equipped with moisture sensors that will determine the overall length of the drying cycle dependent on type and weight of garments and residual moisture. At the conclusion of the drying cycle, the dryer drum will continue to tumble in an automatic “air fluff” cycle to minimize wrinkles. Air fluff may continue as long as the dryer door is closed and a new program is not entered to the machine.

7. As the indicator panel on each dryer 28 and 30 indicates completion of the drying cycle, the door may be opened and clothing removed in Step 114. Unload a quantity of dry garments directly to the clean working surface 36. If clean working surface 36 space and garment type permits, retrieve all items from the dryer 28 or 30, closing the dryer door afterwards. If items remain in the dryer, assure the starting of an air fluff cycle.

8. When a dryer 28 or 30 is emptied, assure that the customer order identification is retrieved and placed with the dry material at the clean working surface 36.

The continuation of Step 114, the folding operation, begins when a dryer 28 or 30 is opened, and a partial or full dryer load is removed to the clean laundry working surface 36. The operation ends when all items in the order are folded or placed on hangers, ready for packaging in home delivery bags or plastic hanger cover bags in Step 116. If the customer order specifies hangers, a supply may be placed on one of the hanger rods 26 at the clean working surface 36 or directly on the working surface 36. Depending on the size of the order, a minimum of about 10-15 hangers should be available. In general, dryer loads containing shirts, pants or slacks, and other items to be hung on hangers should be processed first. Those containing flat items, such as sheets and towels, or those containing heavy items, such as jeans, may be processed later.

When the dryer control display indicates a load is finished, the operator should open the dryer door, allow rotation to stop, grasp a quantity of dry garments, and place them onto the clean working surface 36. Depending on the type of item, the operator may grasp a second load and place it onto the working surface 36. The operator should close the dryer door and restart the dryer to keep remaining items from wrinkling excessively.

The following steps offer the preferred method of selecting and folding the items.

1. Position the piles of garments to provide a clear working surface for folding. In “white” loads or loads without shirts or slacks, select larger items (such as towels or sheets) first, folding these and placing them aside on the working surface. Avoid “burrowing” into the pile, but simply take items that are close and not tangled.

2. Next, choose items that must be hung, such as dress shirts, slacks, sport shirts, and similar items. Turn items “right side out” as needed.

3. Group similar items together on the hanger rod 26, for example, knit shirts, dress shirts, and slacks/pants. Hang items that are part of a uniform together, for example work shirt and pants.

4. Place folded clothing into several stacks on the clean working surface 36 according to types of garment. For example, keep sheets, towels, undergarments, etc. in separate stacks. If possible, keep stacks of approximately equal height; this will aid in packaging for customer delivery in Step 116. Keep clothing stacks toward the back and sides of the working surface to allow room for folding additional pieces.

5. Zip pant fly zippers before folding or hanging. On button flys, attach only the topmost button.

6. As the folding for the current load nears completion, return to the dryer 28 or 30 and retrieve more items, repeating the above steps until all dryers are emptied. Dryers 28 and 30 should continue to rotate with no heat until emptied; after the last items are removed, leave the dryer door open.

7. Small pieces such as socks, undergarments, handkerchiefs, and similar items should be among the last items left on the sorting working surface 36. Match socks, if possible, and fold. Place unmatched socks with others.

8. Do not start to process an order for another customer until the working surface and hanger rod(s) 26 are clear of items for the current order.

The preferred method includes the following additional instructions for hanging garments:

1. Items which must be hung should be placed on a hanger, hung on the hanger rod 26, and buttons closed. For full-length front-buttoned shirts, button a top button and a button mid-way down the garment. Button any lapel buttons that have been undone. It is generally not preferable to attach all front placket buttons on a garment.

2. The front of garments and the open side of hanger hooks should all face in the same direction on the hanger rod 26.

3. Make sure all collars are flat and unwrinkled, and that lapel buttons, if any, are buttoned.

4. Be certain that items are hanging straight without twists or wrinkles in shirttails or sleeves.

Step 116, the packaging operation, begins when folded or hangered clothing items are removed from the clean laundry working surface 36 and placed into plastic delivery bags. It ends with the filled, secured, and identified bags for a single customer order placed on the transport medium 10 as finished goods in Step 118.

The operator should assure a supply of delivery bags in the work area. Based on a visual evaluation of the quantity of folded garments, the operator should obtain bags as necessary to accommodate the order size from the supplies storage area 34, and place them to the clean laundry working surface 36. The bag should be opened and placed on the clean laundry working surface 36.

The preferred method of filling the bag with folded items is as follows:

1. Attempt to keep similar items together. For example, if there is more than one bag in the order, flat, non-wearable items such as sheets and towels should be placed together in a bag, with garment items in other bag(s).

2. Children's items should be kept separate from adult items if possible.

3. Similar items should be packed together. For example, pack men's or women's undergarments together. Pack “Tee” or polo shirts together, collared knit or dress shirts together, and jeans together. Socks should also be kept together in a single bag.

4. In general, consideration should be given to the customer and the logical order in which clothing will be unloaded and put away in the home. Keep “wearable” items separate from “non-wearables” which may be stored in another area of the home.

5. Fill the bags about three-quarters full, allowing room to close and seal the top without disturbing or wrinkling contents. It is preferable to have an additional bag rather than to “overstuff” a few items.

When all items have been packed, the operator should seal the bags and attach customer receipts on the top right-hand corner of the large side surface, assuring that tickets are placed consistently on all bags in the order.

If there are no hanger bags in the order, the operator should place the completed bags to the overhead transport medium 10 for removal from the work area as shown in Step 118. The operator should keep heavier bags on the lower area of carriers. If the order includes too many bags for one carrier on the transport medium 10, the operator may place the excess bags on the next carrier on the transport medium 10. If the order contains hangers, the above steps should be followed, except that the bags with folded garments should not be placed on the outgoing transport medium without items on hangers from the same order. All items, folded and on hangers, should be disposed to the transport medium 10 when the order is completed such that no partial orders are moved from the work area.

Returning to Step 116, the following procedure is used to prepare garments on hangers for delivery. The operator should assure a supply of rolled lightweight plastic hanger bags and twist-ties in the hanger area 32 and position the bagging post located at that area at a comfortable height. The operator should place hangered garments on the bagging post in groups of about 3 to about 5, observing that matching items from uniforms should be kept together, the front of garments and the open side of hanger hooks should all face in the same direction on the bagging post, and men's, women's, and children's items should be separated.

With garments on the bagging post, the operator should pull a plastic bag from the overhead roll over the post and insert hand(s) to open the bag bottom fully and pull the bag over the garments, toward the bottom of the hanging clothes. As the bag is pulled down, the operator will look for the perforation between bags and tear it to free the bag over the clothing from the roll. The operator should pull the bag completely down over the garments so that the top of the bagging post with hanger hooks passes through the small pre-cut opening in the bag.

The operator should take care to assure that the bag is straight and square on the garments. The operator will place a twist-tie around the grouped hangers at the base of the hook while avoiding the post, and twist the tie securely. While holding the bagged garments with one or both hands at the hanger hooks, the operator should depress the foot control to allow the bagging post to fall away. Next, the operator will place the hanger bag on a hanger rod that may include the hanger rods 26 and repeat this process until all hanger items are bagged. When all hanger bags are complete, the operator should attach customer receipts to the top right corner of each bag, at the “shoulder” area of the hanger, taking care to avoid garments if a hand stapler is used.

When all items (folded and hangered) have been completed, the operator should place the order on the transport medium 10 carrier to be removed from the work area for delivery as indicated in Step 118. If all packages (folded and hangered) cannot be loaded to a single carrier on the transport medium 10, the operator may fill adjacent carriers on the transport medium 10. All items, folded and hung, must be placed on the transport medium 10 when the order is completed such that no partial orders remain at the work area.

The following example illustrates potential labor productivity improvements that may be realized by use of machines grouped as modules 2 and 4.

### EXAMPLE 1

Operations at a pilot consumer laundry plant were reviewed to evaluate the potential for productivity improvements using the present invention. In the course of Industrial Engineering time and motion studies conducted at the facility, “baseline” standard times were established from which specific improvements in task performance time could be determined as specific features of the invention were applied. Some improvements were shown possible with little or no additional investment in material, equipment, procedures, training, or space. Implementation of certain additional improvements of the present invention would require some “fit for purpose” investment and planning for implementation.

These are summarized below, starting with an “Original measurements” time value that is based on initial observations by a staff member of the pilot plant facility. All additional data is based on results from Industrial Engineering time and motion studies.

TABLE 1
Baselines

| Source and Description | Minutes per Pound |
|---|---|
| Original measurements | 2.320 |
| In-store time studies, baseline standard | 1.714 |
| for current operations | |
| In-store time studies, improvement potential | 1.200 |
| for current operations | |
| In-store time studies, improvement potential for “fit | 1.146 |
| for purpose” operations in the same facility | |
| (pilot plant) | |

The following shows a tabulation of additional incremental process improvements that have been identified and are offered by the present invention when implemented as a custom-built “fit for purpose” facility.

TABLE 2
“Fit for Purpose” Improvements (New Facility)

| Description of Improvement | Differential Labor Minutes |
|---|---|
| Elimination of bag transport | 0.013/pound |
| to the working surface | |
| Elimination of procuring empty | 0.632/order |
| carts for sorting | |
| Elimination of transporting | 0.013/pound |
| carts to washers | |
| Elimination of transporting | 0.013/pound |
| carts to dryers | |
| Elimination of transporting | 0.012/pound |
| carts to folding area | |
| Elimination of “draping” items | 0.069/pound |
| from dryers to cart crossbars | |
| Elimination of transporting completed | 0.013/pound |
| orders to a finished goods staging area | |
| Elimination of working surface cleanup | 0.202/order |
| improvement in hanger bagging operation | 0.028/pound |
| Reduction in shift cleanup time allowance | See below |

These improvements would generate an aggregate “Per Order” Labor Savings of 0.834 Standard Minutes and an aggregate “Per Pound” Labor Savings of 0.161 Standard Minutes for a total improvement of 6.630 Standard Minutes, based on a 36 pound order.

Applying this differential to the total standard minutes per pound developed in the earlier study (“fit for purpose” in the same facility, Table 1), the “should cost” fulfillment standard is now reduced to 0.962 Standard Minutes/Pound.

A further reduction is anticipated, due to an easier and more confined shift cleanup process. This is estimated to reduce the cleanup time allowance included in the standard times by 15 minutes. With this reduction, the “should cost” fulfillment standard is 0.928 Standard Minutes/Pound or 33.408 Minutes for the example 36 pound order.

From the foregoing, it will be observed that numerous variations and modifications may be effected without departing from the true spirit and scope of the novel concepts of the invention.

What is claimed is:

1. A system for laundering a plurality of independent loads of household laundering comprising at least one first module having a first perimeter, each first module comprising:
at least one first dirty laundry working surface;
at least one first clean laundry working surface;
at least one first washing machine;
at least one first dryer; and
at least one first cart; wherein the at least one first dirty laundry working surface and the at least one first clean laundry working surface are disposed between the at least one first washing machine and the at least one first dryer.

2. The system of claim 1 further comprising at least one second module having a second perimeter, each second module comprising:
at least one second dirty laundry working surface;
at least one second clean laundry working surface;
at least one second washing machine;
at least one second dryer; and
at least one second cart; wherein the at least one second dirty laundry working surface and the at least one second clean laundry working surface are disposed between the at least one second washing machine and the at least one second dryer.

3. The system of claim 2 wherein a portion of the first perimeter is a portion of the second perimeter forming a common perimeter.

4. The system of claim 1 wherein each first dirty laundry working surface and each first clean laundry working surface are within about seven feet of each first washing machine and each first dryer.

5. The system of claim 2 wherein each second dirty laundry working surface and each second clean laundry working surface are within about seven feet of each second washing machine and each second dryer.

6. The system of claim 1 wherein each first dirty laundry working surface and each first clean laundry working surface are within about five feet of each first washing machine and each first dryer.

7. The system of claim 2 wherein each second dirty laundry working surface and each second clean laundry working surface are within about five feet of each second washing machine and each second dryer.

8. The system of claim 1 further comprising a transport medium capable of delivering laundry to the first module.

9. The system of claim 2 further comprising a transport medium capable of delivering laundry to the second module.

10. The system of claim 3 further comprising a transport medium wherein the transport medium forms a portion of the common perimeter.

11. The system of claim 1 further comprising an identification system capable of tracking the plurality of independent loads.

12. The system of claim 1, wherein the identification system further comprises an electronic database having a record related to each load.

13. The system of claim 1 further comprising at least one table wherein each first dirty laundry working surface is located on the table.

14. The system of claim I further comprising a table wherein each first clean laundry working surface is located on the table.

15. The system of claim I further comprising at least one table wherein at least one first dirty laundry working surface and at least one first clean laundry working surface is located on at least one table.

16. The system of claim 1, wherein each first cart is less than about fifteen feet from the at least one first working surface.

17. The system of claim 2, wherein each second cart is less than about fifteen feet from the at least one second working surface.

18. The system of claim 1, wherein the system further comprises at least one large washing machine wherein the at least one large washing machine has a capacity that is larger than the at least one first washing machine.

19. The system of claim 1, wherein the system further comprises at least one large dryer wherein the at least one large dryer has a capacity greater than the at least one first dryer.

20. A system for laundering a plurality of independent loads of laundry at a commercial facility comprising:
a plurality of modules having perimeters, including a first module and a second module, wherein each module comprises:
at least one dirty laundry working surface;
at least one clean laundry working surface;
at least one washing machine;
at least one dryer; and
at least one cart;
wherein in each module, the at least one dirty laundry working surface and at least one clean laundry working surface are disposed between the at least one washing machine and the at least one dryer;
wherein the first module and the second module have a partial common perimeter;
a transport medium adapted to connect each module;
a storage area connected to the transport medium; and
at least one identification system capable of tracking each independent load.

21. The system of claim 20, wherein the identification system comprises an electronic database having a record for each customer and washing load to be processed.

22. The system of claim 20, wherein the transport medium comprises at least a portion of the perimeter of the first module.

23. The system of claim 20 further comprising at least one table having a divider capable of providing a location for at least one dirty laundry working surface and at least one clean laundry working surface.

24. A method of laundering a plurality of independent loads of laundry comprising the steps of:
(a) receiving a first load;
(b) sorting the first load on a dirty laundry working surface wherein sorting further comprises dividing the first load into darks, whites, and mixed colors by:
placing darks into a first wheeled laundry cart;
placing whites into a second wheeled laundry; and
placing mixed colors into a third laundry cart;
(c) rolling each cart to a washing machine within about ten feet of the working surface;
(d) emptying each cart into a washing machine and activating each washing machine;
(e) removing the washed laundry from each washing machine;
(f) placing the washed laundry into a cart;
(g) rolling each cart around the working surface to a plurality of dryers;
(h) loading each dryer with the washed laundry;
(i) activating the dryers;
(j) removing the dried laundry from the dryers
(k) placing the dried laundry into a cart;
(l) moving each cart to the working surface disposed between the washers and the dryers;
(m) folding the laundry;
(n) placing the laundry on hangers; and
(o) packaging the laundry for customer delivery.

25. The method of claim 24, further comprising the step of removing the laundry from a transport medium prior to Step (a).

26. The method of claim 24, further comprising the step of placing the processed clean laundry on a transport medium following Step (o).

27. The method of claim 24 further comprising the step receiving a second load.

28. The method of claim 26, further comprising the step of tracking an identification associated with each load of laundry.

29. The system of claim 3, wherein
the first module comprises a first rectangle comprising the common perimeter as a common edge, a first edge opposed to and substantially parallel to the common edge, the common edge being substantially normal to a second edge, the rectangle further comprising a third edge opposed to and substantially parallel to the second edge;
the second module comprising a rectangle comprising the common edge and a fourth edge opposed to and substantially parallel to the common edge, the common edge being substantially normal to a fifth edge, the rectangle further comprising a sixth edge opposed to and substantially parallel to the second edge; and
the transport medium comprises at least the first edge and the fourth edge.

30. The system of claim 22, wherein
the first module comprises a first rectangle comprising the common perimeter as a common edge, a first edge opposed to and substantially parallel to the common edge, the common edge being substantially normal to a second edge, the rectangle further comprising a third edge opposed to and substantially parallel to the second edge;
the second module comprising a rectangle comprising the common edge and a fourth edge opposed to and substantially parallel to the common edge, the common edge being substantially normal to a fifth edge, the rectangle further comprising a sixth edge opposed to and substantially parallel to the second edge; and
the transport medium comprises at least the first edge and the fourth edge.
